(19) United States
(12) Patent Application Publication
(10) Pub. No.: US 2016/0217522 A1
(43) Pub. Date: Jul. 28, 2016

(54) REVIEW BASED NAVIGATION AND PRODUCT DISCOVERY PLATFORM AND METHOD OF USING SAME

(71) Applicant: Rare Mile Technologies, Inc., Sunnyvale, CA (US)

(72) Inventors: Amit Jnagal, Sunnyvale, CA (US); Pallav Tandon, Sunnyvale, CA (US); Pratyusha Rasamsetty, Sunnyvale, CA (US)

(21) Appl. No.: 15/064,461

(22) Filed: Mar. 8, 2016

Related U.S. Application Data
(63) Continuation-in-part of application No. 14/639,238, filed on Mar. 5, 2015.
(60) Provisional application No. 61/949,884, filed on Mar. 7, 2014.

(51) Int. Cl. G06Q 30/06; G06F 17/30

(52) U.S. Cl. CPC G06Q 30/0627; G06F 17/30861; G06Q 30/0643

(57) ABSTRACT

A system for providing review based navigation on an e-commerce website, generally includes a product discovery system for responding to an user query and navigation request to discover and shop for a product with specific traits and features; a trait discovery system for predictively determining a list of traits of the product which exactly matches the product queried by the end user and a data integration system for matching a query by the end user to a product associated with the list of product traits and for matching the query by the end user to a product review with the list of traits for the product desired by the end user.

### CROSS REFERENCE TO A RELATED APPLICATION

This application is a continuation-in-part of U.S. patent application Ser. No. 14/639,238, filed Mar. 5, 2015; which is a continuation-in-part of U.S. Patent Application Ser. No. 61/949,884, filed on Mar. 7, 2014. Each of these applications are incorporated herein by reference as those each is fully set forth in detail.

### FIELD OF THE INVENTION

This invention relates generally to data processing and more particularly, to a system for providing review based navigation and product discovery on an eCommerce website in a fast and efficient manner.

### BACKGROUND OF THE INVENTION

It is known that some existing eCommerce marketplaces provide product information from multiple merchants, enabling a user to compare, choose, and buy products online. For example, a customer can be browsing an eCommerce marketplace looking for a comfortable pair of sneakers that would be perfect for recovery from a recent knee surgery. The customer can start browsing in a way most customers would, by using keywords and going down the site hierarchy. After spending some time looking at sneakers, the customer maybe lucky enough or skilled enough to filter down to a few choices. However, more often than not, the customer may still be looking at a great number of choices. Therefore, it would be highly desirable to have a new and improved review based navigation system and product discovery platform that would reduce the number reviews that a customer needs to consider in making a product selection decision.

A customer may also sort the candidate sneakers by relevance and read what other customers are saying about the “comfort” level of the sneakers but the top products sorted by relevance may have hundreds or even thousands of reviews. At this point, the customer may give up the idea of an on-line purchase and decide to check out a local store instead for a personal sneaker fit. Thus, existing eCommerce marketplaces do not provide an efficient way of allowing customers to quickly find a customer review of a product containing a specific feature related to a product, e.g. whether sneakers are comfortable for people with recent surgeries. Therefore, it would be highly desirable to have a new and improved review based navigation system and product discovery platform that provides an efficient way of allowing customers to quickly find a customer review of a product containing a specific trait or feature related to the product.

It is also known that current eCommerce websites include product navigation that is basically category limited (e.g., Amazon has categories for books, Kindle®, electronics, and furniture). A department store's website may have categories for home, bed and bath, women's clothing, men's clothing, kids, etc. In most, if not all of these situations, navigation is driven by a product manufacturer's or merchandizer's perspective rather than that of a shopper. Furthermore, the categories are not always useful for navigating the site for a particular feature/attribute that the end user desires, for example finding a sneaker with an arch support for people with recent surgeries. Therefore, it would be highly desirable to have a new and improved review based navigation system and product discovery platform that provided a more efficient product navigation system.

It is still further known that an eCommerce website search feature may be structured with a free form text search which is ideal for shoppers who know exactly what product and product trait they desire. Such free form text searching can provide an effective way of connecting shoppers with product attributes as specified by a manufacturer or merchandizer. Some websites even allow a customer to search for a specific item, however free form searching is not very effective and is not very helpful unless the shopper knows exactly what he or she desires. Furthermore, the effectiveness of the search results is heavily dependent on the keywords used by the shopper. If the shopper does not enter the correct keywords, the search may become tedious and even futile. Therefore, it would be highly desirable to have a new and improved review based navigation system and product discovery platform that does not have to heavily rely on the shopper entering exact keywords to properly conduct an effective search.

In order to assist website shoppers, faceted navigation may be employed to help a shopper narrow down search results in finding relevant products if the shopper knows what product and product traits are desired. However, faceted navigation represents products from the point of view of a manufacturer or a merchandizer which does not help shoppers who are unsure of what they desire. Again, if a shopper does not enter the correct searching information, the search may become tedious and even futile. Therefore, it would be highly desirable to have a new and improved review based navigation system and product discovery platform that avoids the negative aspects of faceted navigation.

It is also known that reviews and opinions of other website shoppers regarding products they purchased, if made available, allow a current shopper to make a decision based on the feedback of a prior shopper. Ideally, these reviews offer an unbiased view from the perspective of a prior shopper, as opposed to the perspective of a manufacturer or merchant. Also, shoppers generally find the reviews and opinions of a prior shopper to be more trustworthy, as such reviews and opinions may contain information about aspects of the product that the manufacturer and/or merchandizer may have overlooked. However, this type of product discovery may become very tricky, if not impossible, to navigate as there may be conflicting opinions by different shoppers. Moreover, some comments may be too long making it too difficult to find relevance if the shopper is looking for information about a specific product feature or attribute. Therefore, it would be highly desirable to have a new and improved review based navigation system and product discovery platform that is able to analyze the prior shopper reviews and present the analysis to the website shopper in a highly efficient manner.

There are also other problems associated with using prior shopper reviews and opinions as a mechanism for product discovery. Specifically, as the number of reviews may be great, e.g. thousands or even more, there is not an efficient way to find a review that relates to the trait of a product which is important to the customer. Furthermore, there is currently no way of getting information concerning specific product traits which may be important to the customer without going through all of the prior customer reviews. Therefore, it would be highly desirable to have a new and improved review based navigation system and product discovery platform that provided information concerning trait aspects of the product considered important to the website customer without the need of the shopper going through all of the prior customer reviews.

There have been many attempts at solving the above-mentioned problems with systems which present keywords obtained from users in a review process to an end user. Such systems identify product characteristics from customer reviews using various analyses of the product review text. See for example, U.S. Pat. No. 7,620,651 to Chea et al., U.S. Pat. No. 7,930,302 to Bandaru et al., U.S. Pat. No. 8,515,828 to Wolf et al., U.S. Pat. No. 8,554,701 to Dillard et al., U.S. Pat. No. 8,700,480 to Fox et al., U.S. Pat. No. 8,712,868 to Foster et al., U.S. Pat. No. 8,799,773 to Reis et al., U.S. Pat. No. 8,818,788 to Mihalik et al., U.S. Pat. No. 8,843,430 to Jojic et al., U.S. Patent Application 2009/0063247 to Burgess et al., U.S. Patent Application 2010/0169317 to Wang et al., and U.S. Patent Application 2011/0184729 to Nam. While the use of such systems in considering prior customer reviews may have been generally satisfactory, there is nevertheless a need for a new and improved data processing system for providing review based navigation via a set of text analytic and text mining engines that provides an efficient way of allowing an end user customer to quickly find a specific product feature or trait related to a product based on previous customer reviews.

It is a purpose of the present invention to fulfill this and other needs in the art in a manner more apparent to the skilled artisan once given the following disclosure.

### BRIEF SUMMARY OF THE INVENTION

A first aspect of the present invention is a review based navigation product discovery platform which is made available to an end user through an e-commerce website. The product discovery system is one which an end user uses to discover and shop for products having specific features and traits desired by the end user. Product discovery, in this instance, refers to either using site search engine queries or guided site navigation made available on an eCommerce website. The review based navigation product discovery platform matches end user queries for a product with specific traits to prior customer reviews associated with such a product but directed to the specific features and traits desired by the end user.

In one embodiment of the first aspect of the present invention, the product discovery means includes product data storage means for providing information regarding a product, wherein the product data storage means is coupled to a merchant's web site, product review data storage means for storing information related to a user review of a product item, a product name and a product type, and a product site search index for responding to the end user query and the navigation request.

In another embodiment of the first aspect of the present invention, the traits discovery means includes review collection means for collecting a plurality of user reviews, sentiment analysis means for analyzing the plurality of user reviews to determine a sentiment of the plurality of user reviews, traits discovery means for discovering a desired product trait, a review pre-processing means for processing the plurality of user reviews, and a product trait association means for associating a product trait to a product.

In yet another embodiment of the first aspect of the present invention, the traits discovery storage means further includes product reviews storage means for storing traits of the product which are extracted from a user generated content store, traits model storage means for listing of traits of the product which can be utilized for product discovery, traits data storage means for storing a data dictionary, and traits product mapping means for storing a mapping of traits to each product and product review to which the trait belongs and an association score for displaying to the end user.

In still another embodiment of the first aspect of the present invention, the data dictionary further includes synonyms, n-grams, and stop words, and traits and the groups of traits identified during a pre-processing stage of data.

In still yet another embodiment of the first aspect of the present invention, the data integration means further includes search index enrichment means for providing information related to a product and traits association data which is located in the search index of the merchant's website.

In a further embodiment of the first aspect of the present invention, the data dictionary includes a product type data dictionary and a global data dictionary.

In a still further embodiment of the first aspect of the present invention, the traits mapping means includes means for normalizing punctuation.

A second aspect of the present invention is a method for providing review based navigation on an e-commerce website, the method comprising the steps of: receiving, from a user, a query concerning a specific feature associated with a product; performing a sentiment analysis of a plurality of reviews associated with the product, wherein the sentiment analysis includes contextualization of the product based on the specific feature present in the plurality of reviews associated with the product; and facilitating navigation of the e-commerce website based on the sentiment analysis, wherein facilitating navigation includes displaying, in response to the query, a contextualized product, wherein the displaying the contextualized product includes displaying the strengths and weaknesses of the specific feature associated with the product and one or more portions of the plurality of reviews, the one or more portions being relevant to the specific feature.

In one embodiment of the second aspect of the present invention, the method further includes the steps of extracting traits and features from the plurality of reviews associated with the product, and tagging the traits and features to a product within a product database to further enrich an activity which relies on how consumers view the product.

In another embodiment of the second aspect of the present invention, the facilitating navigation step includes the step of using a site search query to find relevant products.

In yet another embodiment of the second aspect of the present invention, the facilitating navigation step includes the step of using a guided site navigation to find relevant products.

In still another embodiment of the second aspect of the present invention, the step of performing a sentiment analysis includes the step of determining predictively an exhaustive list of traits to be used for a discovery of the product.

In still yet another embodiment of the second aspect of the present invention, the step of performing a sentiment analysis includes the step of associating discovered traits to a product item and a product review.

A third aspect of the present invention is at least one non-transitory computer-readable medium storing computer-readable instructions that, when executed by a computing device, cause the computing device to: receive, from a user, a query concerning a specific feature associated with a product; perform a sentiment analysis of a plurality of reviews associated with the product, wherein the sentiment analysis includes contextualization of the product based on the specific feature present in the plurality of reviews associated with the product; and navigate the e-commerce website based on the sentiment analysis, wherein navigate includes displaying, in response to the query, a contextualized product, wherein the displaying the contextualized product includes displaying the strengths and weaknesses of the specific feature associated with the product and one or more portions of the plurality of reviews, the one or more portions being relevant to the specific feature.

In one embodiment of the third aspect of the present invention, the at least one non-transitory computer-readable medium includes extract traits and features from the plurality of reviews associated with the product, and tag the traits and features to a product within a product database to further enrich which activity relies on how consumers view the product.

In another embodiment of the third aspect of the present invention, navigate causes a site search query to find a relevant product.

In still another embodiment of the third aspect of the present invention, navigate causes a guided site navigation to find a relevant product.

In yet another embodiment of the third aspect of the present invention, perform includes a sentiment analysis to predictively determining an exhaustive list of traits to be used for a discovery of the product.

In still another embodiment of the third aspect of the present invention, perform includes a sentiment analysis to associate discovered traits of a product item and a product review.

The preferred system and method for providing review based navigation on an e-commerce website, according to various embodiments of the present invention, offers the following advantages: ease of use; improved ability to discover and shop for products; improved ability to analyze product reviews; improved ability to find traits which are commonly used by customers to search products; and improved ability to tag the products with the terms which represent the traits are optimized to an extent that is considerably higher than heretofore achieved in prior, known review based navigation systems on an e-commerce website.

### BRIEF DESCRIPTION OF THE DRAWINGS

The above mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIGS. 1A and 1B are schematic illustration of a review based navigation and product discovery system which is constructed according to the present invention;

FIG. 2 is a schematic illustration of a screen shot of an uncovered product discovery with contextualized reviews, as generated by the system of FIGS. 1A and 1B;

FIGS. 3A and 3B are schematic illustrations of lexicon database structures for use by the system of FIGS. 1A and 1B;

FIGS. 4A-E are flowcharts illustrating the overall process flow of the review based navigation and product discovery system of FIGS. 1A and 1B;

FIG. 5 is a schematic illustration of typical cue phrases, traits and themes, for use by the system of FIGS. 1A and 1B; and

FIG. 6 illustrates how a relevance score as well as a sentiment score are assigned to a review-trait association

### DETAILED DESCRIPTION OF THE PREFERRED EMBODIMENTS

To facilitate a complete understanding of the invention, the following terms and acronyms are used throughout the detailed description:

Client-Server. A model of interaction in a distributed system in which a program at one site sends a request to a program at another site and waits for a response. The requesting program is called the “client” and the program that responds to the request is called the “server.” In the context of the World Wide Web (discussed below), the client is a “Web browser” (or simply “browser”) which runs on a computer of a user; the program which responds to browser requests by serving Web pages, or other types of Web content, is commonly referred to as a “Web server.”

Content. A set of executable instructions that is served by a server to a client and which is intended to be executed by the client so as to provide the client with certain functionality. Web content refers to content that is meant to be executed by operation of a Web browser. Web content, therefore, may include, but is not limited to, one or more of the following: HTML code, Java Script™., Java Program(s) and C-“Sharp” code.

HTML (HyperText Markup Language). A standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to display the document. Additionally, in specifying how the Web browser is to display the document.

HTTP (HyperText Transport Protocol). The standard World Wide Web client-server protocol used for the exchange of information (such as HTML documents and client requests for such documents) between a browser and a Web server. HTTP includes a number of different types of messages that can be sent from the client to the server to request different types of server actions. For example, a “GET” message, which has the format GET <URL>, causes the server to return the document or file located at the specified URL.

Hypertext System. A computer-based informational system in which documents (and possibly other types of data entities) are linked together via hyperlinks to form a user-navigable “web.”

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations that may be made in the future, including changes and additions to existing standard protocols.)

N-grams. N-grams are contiguous sequences of n items from a given sequence of text or speech. The items can be phonemes, syllables, letters, words or base pairs, according to the application. The n-grams typically are collected from a text or speech corpus.

Stop Words. Stop words are words which are filtered out before or after processing of natural language data (text). Any group of words can be chosen as the stop words for a given purpose. For some search engines, the most common, short function words, are “the”, “is”, “at”, “which”, and “on”. In this case, stop words can cause problems when searching for phrases that include them.

World Wide Web (“Web”). Used herein to refer generally to both (i) a distributed collection of interlinked, user-viewable Hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP and the Web pages are encoded using HTML.

However, the terms “Web” and “World Wide Web” are intended to encompass future markup languages and transport protocols that may be used in place of (or in addition to) HTML and HTTP.

Web Site. A computer system that serves informational content over a network using the standard protocols of the World Wide Web. Typically, a Web site corresponds to a particular Internet domain name, such as “mybusiness.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users. Importantly, a WebSite can have additional functionality. For example, a Web site may have the ability to print documents, scan documents, etc.

URL (Uniform Resource Locator. A unique address which fully specifies the location of a file or other resource on the Internet or a network. The general format of a URL is protocol://machine address: port/path/filename.

Term or Group of Terms. A trait which an end user uses to discover product for an accepted product type.

Faceted Navigation. A technique for accessing information organized according to a faceted classification system that allows users to explore a collection of information by applying multiple filters.

To provide some perspective that will be helpful in understanding and appreciating the inventive concepts of the present invention, every prior customer review can offer valuable insights about a product such as strengths, weaknesses, value as a gift, fitness for a particular purpose, and various other attributes.

Customers, on average, may read two or three comments for a product prior to making a decision to purchase the product or not. This is because prior customer comments contain a wealth of information that can help customers make decisions regarding the product purchase. However, this information usually is lost because of the amount of reviewing it takes to get to it. The system of the present invention pulls up this information and structures it into an intuitive product navigation to make right product selections an easy task.

### Overview the Review Based Navigation and Discovery System

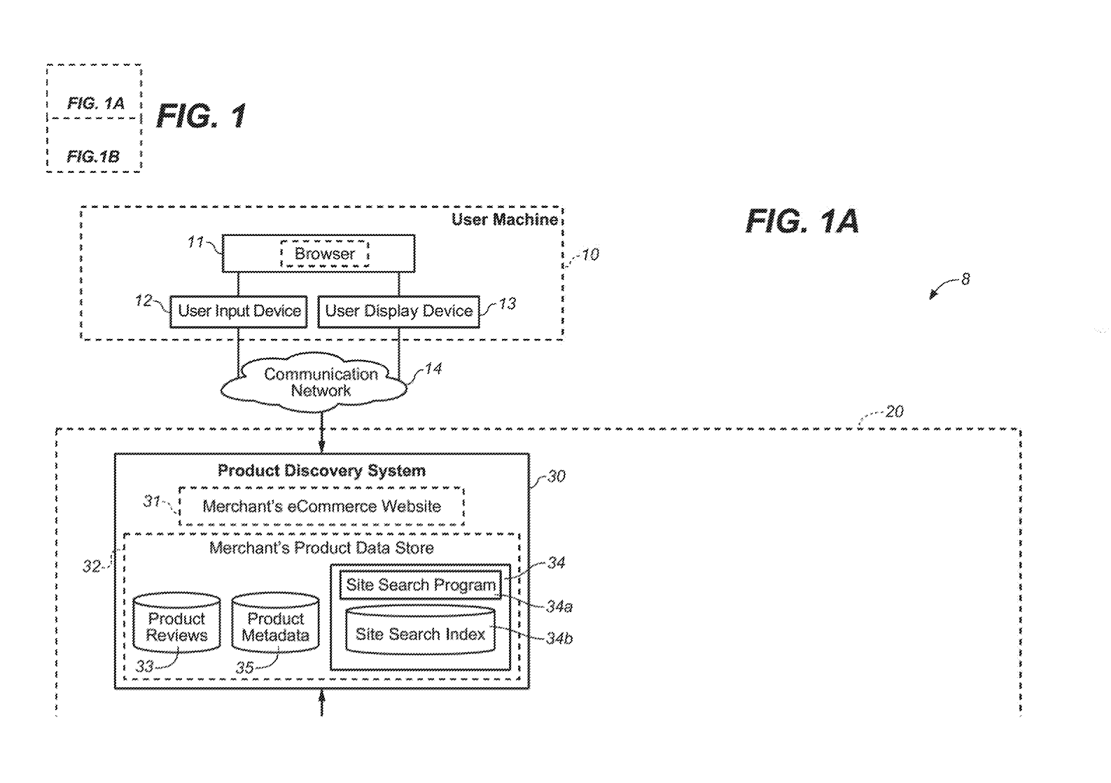

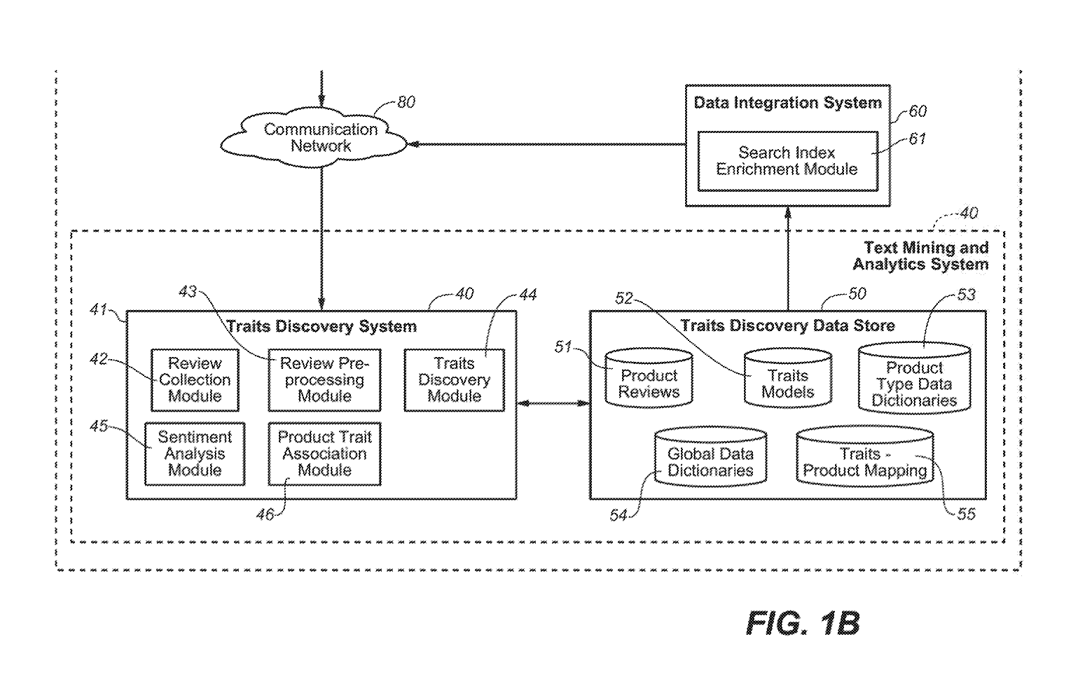

Referring now to the drawings and more particularly to FIG. 1, there is illustrated a distributed system 8. The distributed system 8 is configured for presenting a navigation scheme derived from product reviews to an end user via a merchant's ecommerce website 31 and a communication network 14. The distributed system 8 is further implemented for showing the most appropriate customer product reviews related to a search query or a navigation request made by the end user. The system 8 is further implemented for affecting the relevance of the search results returned to the end user in response to a product search request issued by the end user via the merchant's ecommerce website 31.

Considering now the distributed system 8 in greater detail with reference to FIG. 1, the distributed system 8 generally includes an end user machine 10 and a review based product discovery system 20. The end user machine 10 enables an end user to generate search and navigation requests, while the review based product discovery system 20 responds to such end user generated search and navigation requests. In this regard, the review based product discovery system 20 presents or provides the end user with access to (1) review based navigation information; and (2) review based search results with contextual reviews, as related to customer product searches.

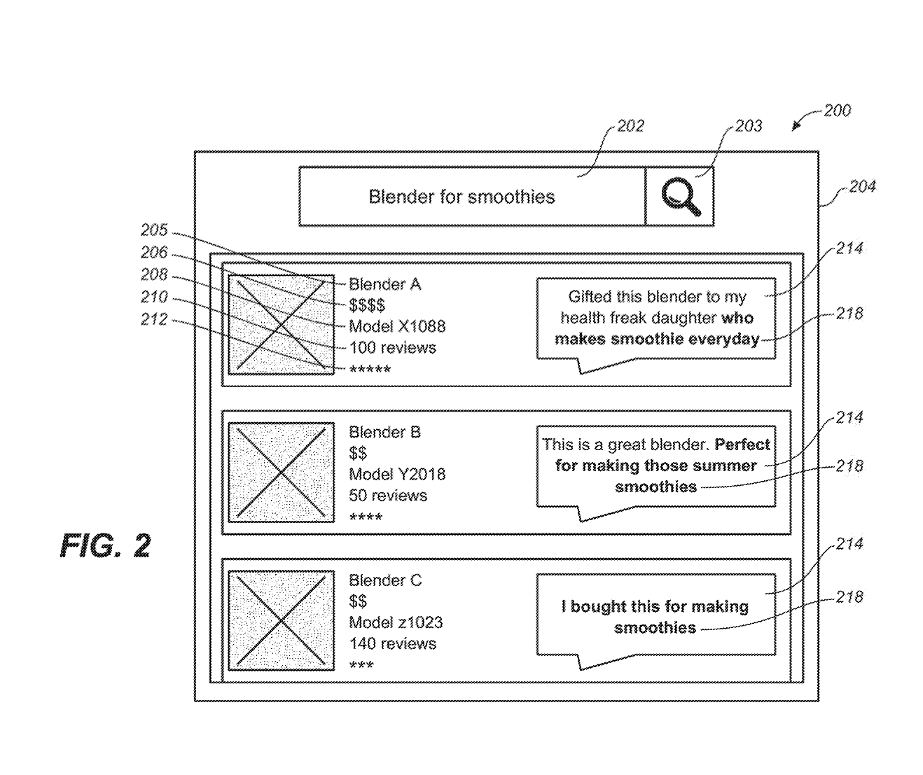

As best seen in FIG. 2, a schematic illustration of a typical uncovered product discovery with contextualized reviews 200 resulting from a typical product search and navigation request. The uncovered product discovery with contextual reviews is presented to the end user via a displayed page 204 on a user display device 13 (FIG. 1). In this regard, the display page 204 presents a visual indication of various products wherein one or more relevant prior customer product reviews, such as a customer product review 214 for each discovered product. Of importance is that each customer product review 214, made available by the distributed system 8, contains a trait, such as a trait 218 or similar spellings of the trait so that the end user can see what a prior customer thought of the discovered product with that trait (such as smoothies). Other information related to each of the products reviewed by prior customers is also presented on the display page 204. For example, a product name 205, the relative cost 206 of the product, a product model 208, the number of prior customer reviews 210 and a customer rating 212, such as a conventional star rating indication. This additional displayed information is shown in order to further assist the end user in making an informed decision regarding the purchase of a desired product (such as a blender) having a desired trait (for example, making smoothies).

### The Review Based Navigation and Discovery Platform

Considering now the user machine 10 in greater detail with reference to FIG. 1, the user machine 10, which enables an end user to communicate with the review based product discovery system 20, generally includes an internet browser 11, a user input device 12 (e.g., a keyboard), and a user output device 13 (e.g., a CRT or LED monitor). The input device 12 and the output device 13 cooperate with one another to send and receive communications between the user machine 10 and the review based product discovery system 20 or, more specifically, the eCommerce merchant website 31 via the communication network 14. As an example, a shopper enters, through the user input device 12, a product (a blender) having a particular trait (for smoothies) such that the product and the trait are displayed on the user display device 13 via a query screen 202 (FIG. 2). Once the product discovery query has been entered by the end user, the end user clicks on a displayed search button 203 (FIG. 2) located adjacent to the query screen 202. Activation of the search button 203 will then cause at least one product to be displayed in a display page, such as the display page 204, on the user output display device 13. This displayed response to the end user query is best described as a product discovery with contextualized review 200, as seen in FIG. 2.

### The Review Based Product Discovery System

The review based product discovery system 20 in FIG. 1 is comprised of various systems and sub-systems which work together in various ways to deliver the overall functions of review based product discovery system 20. Each of these various systems and sub-systems include: (1) a product discovery system 30 is responsible for responding to end user queries issued from the user machine 10. This sub-system 30 responds to the shoppers in real time when the product discovery request is made for searching or browsing products by the user machine 10; (2) a text mining and analytic system 40 which includes a trait discovery sub-system 41 and a traits discovery data store or storage sub-system 50. As will be described hereinafter in greater detail, the trait discovery sub-system 41 includes a traits discovery module 44 which operates on discovered product traits and associates discovered traits to a product. More particularly, the traits discovery sub-system 41 is responsible for discovering traits from user generated content and other content related to product and enriched product related metadata and attributes. The traits discovered and associations identified are stored in the traits discovery data store 50 which is a conventional database; and (3) a data integration system 60 which is responsible for enriching the product discovery system 30 with the traits discovered and stored in system 50.

A communication network 80 configured as a traditional network, such as the internet, allows these systems to communicate with each other. The review based product discovery system 20 is solely responsible for responding to end user queries issued from the user machine 10. The input device 12, forming part of the user machine 10, facilitates the entering of the search queries into the review based product discovery system 20. The search query and navigation requests are processed by the product discovery system 30, which forms part of the review based product discovery system 20, where search and navigation results are returned to the end user machine 10 and displayed via the display device 13.

### The Product Discovery System

Considering now the product discovery system 30 in greater detail, the product discovery system 30 is comprised of the merchant's eCommerce website 31 and a merchant's eCommerce product data store 32. The merchant's eCommerce website 31 in this configuration is a means for the end user to access search and navigation functions, which in turn, allows a website shopper to search products made available via the merchant's eCommerce website 31. For example, a shopper uses the browser 11 to enter a URL for the Merchant's eCommerce website 31. Once the Merchant's eCommerce website 31 is loaded as a webpage on the browser 11, a search box, such as the search box 202 (FIG. 2) is presented to the website shopper to search for products with traits of interest to the website shopper. The merchant's eCommerce website 31, as it interacts with the end user machine 10, also allows the website shopper to browse the merchant's eCommerce website 31 based on product attributes such as price, brand, color, as well as other attributes and traits of interest to the website shopper.

The merchant's eCommerce product data store 32, as best seen in FIG. 1, generally includes a conventional product site search index 34 (including site search program 34a and site search index 34b), a product reviews store 33 which is a database of stored product review data, and a product metadata store module 35, which cooperate to interact with the merchant's eCommerce website 31, as will be explained hereinafter in greater detail. For now, it will suffice to state that the merchant's eCommerce website 31 provides means of accessing the data store 32 and means for issuing product discovery requests to the data store 32. In this regard, when a user query is issued via the merchant's eCommerce website 31 using the user machine 10 (as shown in FIG. 2), search queries are communicated to the product data store 32 which responds with the best matched products and related attribute data, such as attribute 205, 206, its traits along with the corresponding reviews 214, such as reviews 214 which are best associated with the product trait, such as the product trait 218.

Considering now the product site search index 34 in greater detail, the product site search index 34 is a combination of the conventional site search program 34a and the conventional site search index database 34b. The site search index database 34b, under control of the site search program 34a stores attributes and metadata of products sold on the merchant's eCommerce website 31. It is to be understood that product metadata refers to attributes and properties of a product sold on the merchant's eCommerce website 31 such as color, size, price, brands etc. The product site search index program 34a is conventional software implemented to respond to search queries from the end user by scanning the documents stored in site search index database 34b and retrieving those documents which have search keywords present, as attributes of the documents, stored in site search index database 34b.

As will be described hereinafter in greater detail, the discovery of traits from reviews for a product and the association of a trait to a product is performed by the traits discovery module 44, which forms part of the traits discovery sub-system 41 as best seen in FIG. 1.

### Overview Product Metadata Storage

Considering now the merchant's eCommerce product data store 32 in greater detail, the merchant's product data store 32 includes a product metadata store or storage module 35. The product metadata store module 35 is a conventional database which stores product metadata such as product brand, product color, etc. to provide attribute data, such as the attribute data 205, 206, 208, and 212 (FIG. 2) of all the products sold by the merchant on the merchant's eCommerce website 31. An example of a conventional structured computer readable storage system is the Mogo database or the MySQL database. In this regard, the product metadata storage module 35 contains unique computer understandable identifiers, such as Review ID and Product ID, as shown in Table 1 below, for product items, product names and product types, as will be discussed later. All references to a specific product are made using these unique product identifiers. In short, there is a unique product identifier for each product that is made available by the Merchant's eCommerce website 31 for responding to specific end user queries looking for products with specific traits.

### Overview Products Review Storage

Considering now the product review store 33 in greater detail, the product review store module 33 stores user generated product reviews. Like the product data store module 35, the user generated product review store module 33 is a conventional database which provides and makes available unique computer understandable identifiers such as Review ID and Product ID, as shown in Table 1. These product reviews are conventionally provided by other website customers who have previously purchased products from the merchant and who have provided a product review on the merchant's eCommerce website 31. In this regard, the product reviews storage 33 is structured so that each product review comprises; (1) review text, (2) a review star rating, (3) a date when the review was made, and (4) an associated product identifier of the product for which the review was provided and as provided by the product metadata store 35, such as shown in Table 3. As will be discussed later, the associated product identifier such as the Review ID in Table 3 acts as the link between the product and its reviews in all the steps of further processing.

### Overview Product Site Search Index Module

Considering now the product site search index 34 in greater detail, the product site search index 34 is a conventional database whose primary objective is to respond to user search and navigation requests in a fast and efficient manner. The product site search index 34 also functions to store the enriched product data created by the data integration system 60 and its association with product traits identified from the review information in data integration system 60 (as will be hereinafter described in greater detail.) In overview summary, the product site search index 34, determines how relevant a particular product item, name and or type having a particular customer review are to each site search query and navigational request of an end user. The conventional product site search index 34 receives the data from the data integration system 60 via a network connection 80. Network connection 80 is similar to communication network 14.

### Overview of the Analytic and Text Mining System

Considering now the analytic and text mining module or sub-system 40 in greater detail with reference to FIG. 1, the analytic and text mining module or subsystem 40 applies novel text analytics and processing techniques to acquire data in order to fulfill two primary objectives; first, to predictively determine an exhaustive list of traits which could be used for product discovery, and second, to associate discovered traits to product items and reviews. To achieve these objectives, the analytic and text mining module or sub-system 40 includes two primary modules, namely the trait discovery module or sub-system 41 and the trait discovery data store or sub-system 50.

The analytic and text mining module or sub-system 40 implements a unique and novel method to extract product traits from the product reviews via the traits discovery system 41. As will be explained hereinafter in greater detail, a novel machine learning approach or process coupled with natural language processing techniques is applied to extract traits from the review corpus.

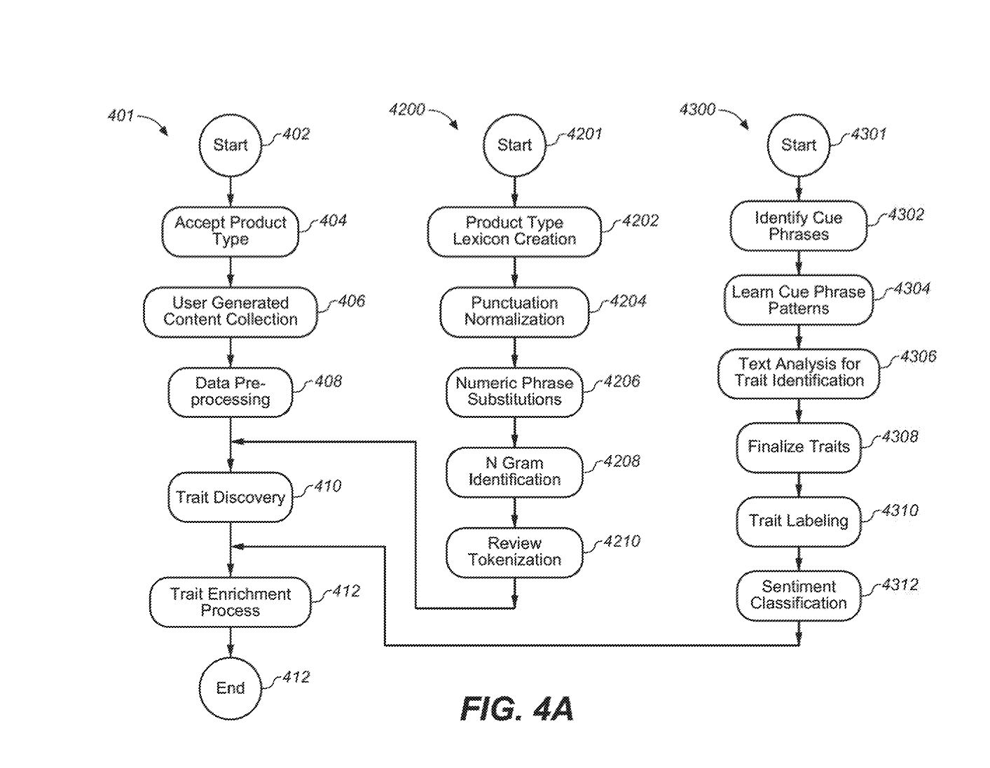

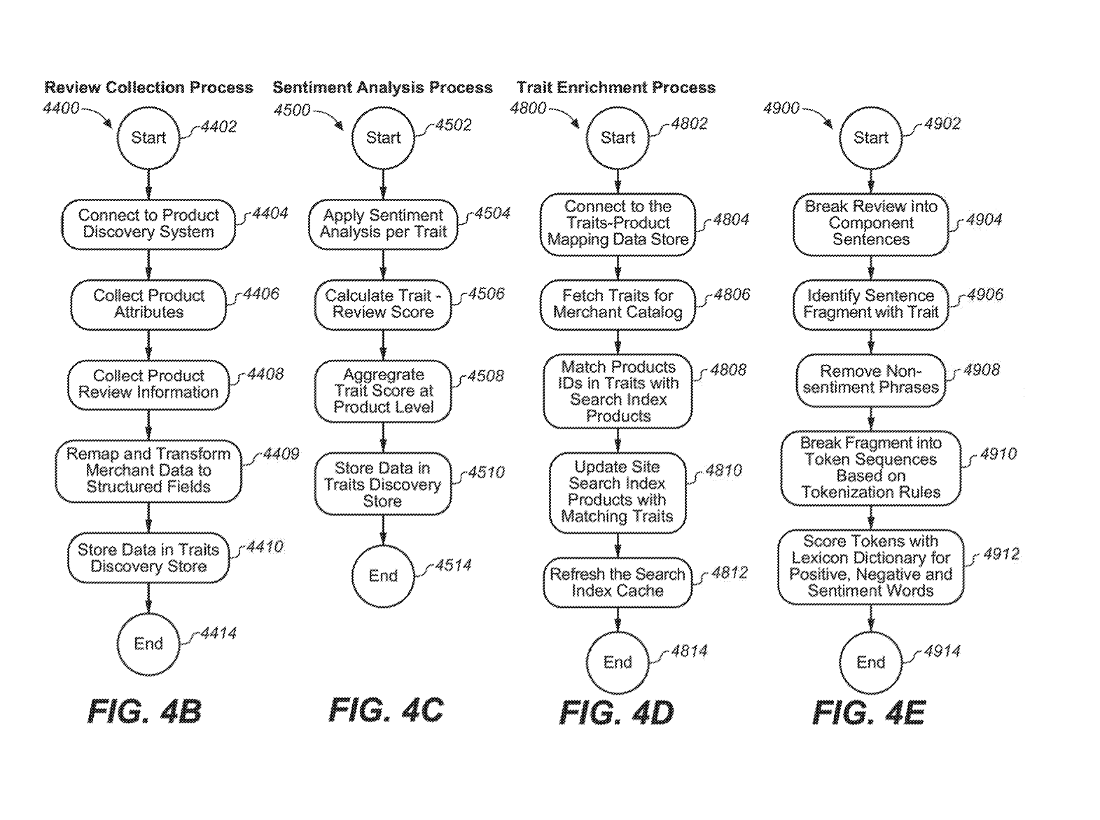

The analytic and text mining module or sub-system 40 also implements a unique and novel association process to associate discovered product traits to product items and product reviews. In this regard, the association of a trait to a product item ensures that whenever an end user query includes such an association request, the review based product discovery system 30 can respond with the correct product item in the provided search results. For example, as shown by a query, such as the query 202 (FIG. 2), the query “blender for smoothies”, it is the shopper's intent is to search for product type “blenders” associated with a trait “for smoothies”. This demonstrates an association between product type “blenders” and trait “for smoothies”. The novel machine learning approach or process associated with the analytics and text mining module 40 cooperates with a sentiment analysis process to determine an association between the traits identified from product reviews and products. The machine learning approach ensures that trait-to-product item association is produced for positively mentioned traits and that a word-sense disambiguated process is applied to extract the true meaning of the words associated with the trait. It is to be understood that word-sense disambiguation is a process to find the right contextual meaning of words. For example, consider these two sentences. “The whole team was fired up to take on the opponents” and “He was fired and let go” In these sentences, the word “fired” has different meanings based on the context and surrounding words. The word-sense disambiguation process determines the meaning of the word based on the context. In summary, each product review is classified as belonging to zero or more traits, which in turn allows the review based product discovery system 20 to generate the most appropriate reviews belonging to a trait when an end user queries a product with such a trait. A traits association routine 4300 (FIG. 4A) facilitates the above-mentioned unique and novel association process will be described hereinafter in greater detail.

The traits discovery data store or storage sub-system 50, as will be described hereinafter in greater detail, is a conventional computer database for all associated processes including those associated with the traits discovery module or sub-system 41 and the data integration sub-system 60 as best seen in FIG. 1.

### The Traits Discovery Module

Considering now the trait discovery module or sub-system 41 in greater detail, the trait discovery module or sub-system 41 includes a set of modules that cooperate with one another to achieve the objectives, as earlier-mentioned. This set of modules includes a review collection module 42, a review pre-processing module 43, a trait discovery module 44, a sentiment analysis or classification module 45, and a product trait association module 46. Each of these modules in the trait discovery module or sub-system 41 will be described hereinafter in greater detail. For now, it will suffice to state that the trait discovery sub-system 41 predictively determines an exhaustive list of traits which can be utilized for product discovery, which traits are then stored in the trait storage sub-system 50, and more particularly in a traits models database module 52 which forms part of traits discovery data store sub-system 50. The traits models database module 52 stores data related to the traits identification process which is explained hereinafter in greater detail. Such traits are extracted from the user generated content store in a product reviews module 51 using a unique and novel trait extraction process 401 (FIG. 4A). The product reviews module 51, which forms part of the traits discovery data store sub-system 50, stores review data for which a product discovery is running. It is to be understood that the products are reviewed on the Merchant's website 31 by shoppers. The process of product review by shoppers is beyond the scope of the disclosure presented herein.

### The Review Collection Module

Considering now the review collection module 42 in greater detail, the review collection module 42 is responsible for collecting all of the customer reviews on a particular eCommerce website, such as the merchant's eCommerce website 31, where customers conventionally post reviews for products they purchase. The review collection module 42 is responsible for extracting the reviews present in the merchant's product data store 32 made available in the product reviews store 51. This operation is accomplished via a user generated review content collection step 406 (FIG. 4A) and a review collection process or sub routine 4400 (FIG. 4B) that will be described hereinafter in greater detail. The review collection process 4400 will sometimes be referred to hereinafter as a user generated review and content collection routine 4400 initiated through the user generated content collection step 406 (FIG. 4A).

### The Review Pre-Processing Module

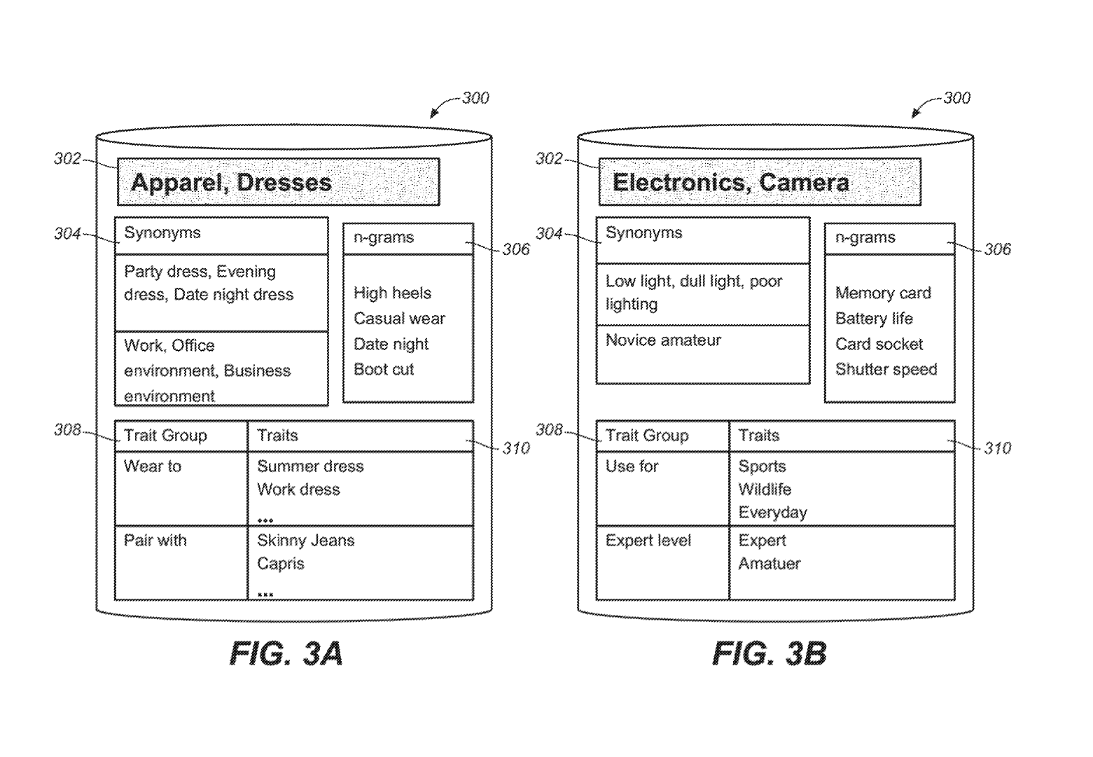

Considering now the review pre-processing module 43 in greater detail, the primary objective of review pre-processing module 43 is to pre-process all of the reviews stored in product reviews storage module 51. The pre-processing involves various steps of text substitutions, punctuation normalization, n-gram identification, and review tokenization. All the steps are described hereinafter in greater detail as part of a data pre-processing sub routine 4200 and call step 408, as best seen in FIG. 4A. The output of the pre-processing steps such as normalized reviews and n-grams are stored in the traits discovery data store 50. More particularly, product reviews are stored in the product reviews storage module 51, n-grams and synonyms (such as synonyms 304 in FIGS. 3A and 3B) are stored in a product type data dictionaries module 53 (such as product type 302 in FIGS. 3A and 3B) and global n-grams, synonyms, and phrases are stored in a global data dictionaries module 54 (such as dictionaries 300 in FIGS. 3A and 3B).

### The Traits Discovery Module

Considering now the traits discovery module 44 in greater detail, the traits discovery module 44 is responsible for extracting the various traits which are found in the product reviews now made available after the pre-processing of the review by the review pre-processing module 43 and stored in the product reviews storage module 51. This operation is accomplished via the traits association sub routine 4300 and call step 410, as best seen in FIG. 4A. The traits association sub routine 4300 will be described hereinafter in greater detail.

### The Sentiment Analysis Module

Considering now the sentiment analysis or classification module 45 (FIG. 1) in greater detail, the sentiment analysis module 45 is responsible for creating a sentiment classification whereby it can identify the sentiment associated with the traits identified in the product review. The sentiment classification module 45 more particularly creates a numerical score for each trait. A score of positive magnitude indicates a positive sentiment for a trait in that review while a score of negative magnitude indicates a trait with negative sentiment in the review. For example, a positive sentiment for a “wireless printing feature of a printer” would be “the printer is great for wireless printing”. A negative sentiment for wireless printing by a printer would be “the wireless connection to the printer is spotty and breaks often”. This process of classification will be described hereinafter in greater detail as part of a sentiment analysis process 4500 (FIG. 4C).

### The Product Traits Association Module

Considering now the product traits association module 46 (FIG. 1) in greater detail, the product traits association module 46 is responsible for associating traits to the products, as shown in Table 1 below. The product traits association module 46, in particular, associates a product with a trait. In doing so, product traits association module 46 also expands a trait into more terms/words which represent the same meaning for the product type and tags the product with those terms/words. An example of trait expansion would be for a trait such as “Great looks”. This will be expanded to “Great design and Great style”. Another example could be a trait “Well made”. This will be expanded to “Well Constructed” and “Well built”. With respect to tags, a printer may have frequent mentions of “well made” in its reviews which is associated with the trait “well made”. In addition to “well made”, the printer is also associated with “well-constructed” and “well built”. A shopper looking for any of the traits well-made/constructed/built will be presented with that printer. The product traits association module 46 also assigns a score of association between the product and the trait, where a score of higher magnitude depicts a stronger association. This score, in turn, indicates to the site search index module 34 to rank a discovered product higher in the search results listing, if the association between the queried trait and the product is strong, as would be indicative of a higher association score. To this end, each product item, name and/or type and each prior customer review are assigned an association score that is stored in a traits product mapping database 55 in the format similar to Table 1 below. For example, the association score may range from 0 to 1.0 with 1.0 being a highest score and 0 being a lowest score (See Table 1).

TABLE 1

| | | | Review | Product |
|---|---|---|---|---|
| | | | Association | Association |
| Trait | Review ID | Product ID | Score | Score |
| Smoothies | R 123 | P 123 | 0.4 | 0.9 |
| Smoothies | R 234 | P 123 | 0.9 | 0.9 |

As can be seen in Table 1, a prior customer Review ID number, R 123 had a relatively high product association score which means that there is a fairly high certainty (0.9 out of 1.0) that the product (blender) which the end user is looking for is reviewed in this particular customer review. However, there is also a below average certainty (0.4 out of 1.0) that the trait (making smoothies) that the end user is looking for in this particular review is contained within this review. Conversely, Review ID number 234 has a relatively high product association score and this review also has a fairly high certainty (0.9 out of 1.0) that the trait is contained within this review.

### Overview of the Trait Discovery Data Store

Considering now the trait storage module or sub-system 50 in still greater detail, the trait storage module or sub-system 50 is a computer based storage system for storing and accessing data during a trait extraction process 401 (FIG. 4A). In this regard, the trait storage sub-system 50 via the product review storage module 51 and the trait model storage module 52 operate to store product and product review data as shown in Table 2 and Table 3 along with those traits identified during the traits association process as shown in Table 2 and Table 3. The traits discovery data store data dictionaries, such as the product type data dictionaries 53 and the global data dictionaries 54, are conventional databases which store synonyms, bigrams, trigrams, stop words, and cue phrases which are explained hereinafter in greater detail. The traits product mapping module 55 stores data that maps traits to products along with reviews to which a trait belongs, and product associated scores, such as depicted in Table 1.

### Overview of the Data Integration System

Considering now the data integration module or sub-system 60 (FIG. 1) in still greater detail, the data integration module or sub-system 60 includes a search index enrichment module 61 which will be described hereinafter in greater detail. For now, it will be sufficing to mention that the data integration module 60 facilitates the sending of the product traits and reviews mapping, via the communication network 80, to the site search index module 34 of the merchant's product data store 32.

Considering now the search index enrichment module 61 in greater detail, search index enrichment module 61 transfers or uploads product and traits association data, such as indicated in Table 1, to the site search index 34 residing in the merchant's product data store 32. The upload process includes conventional computer understandable instructions which, when executed, read each product entry from the traits product mapping data store 55 along with updating the same product record in the product site search index 34. This update step is initiated during a trait enrichment sub routine or process 4800 at an update step 4810 which includes adding the trait data along with the association score to the product record in the site search index 34, as shown in Table 1.

Considering now the trait enrichment routine 4800 with respect to FIG. 4D in greater detail, the trait enrichment routine 4800 begins at a start command 4802. As shown in step 4804, once initiated, the search index enrichment module 61 interacts with the traits product mapping data store 55. In step 4806, search index enrichment module 61 reads the traits, identified as parts of traits association process 4300, from traits product mapping data store 55. In steps 4808 and 4810, system 20 interacts with the site search index 34 and updates the documents or records related to a particular product stored in the site search index database 34b. In Step 4812, the updated data in the site search index database 34b is made available to the merchant's ecommerce website 31 by replacing the old documents or record related to a particular product stored in site search index database 34b with the updated documents or record related to a particular product stored in site search index database 34b.

### Overall System Flow Process

Considering now the traits extraction process 401 in greater detail with reference to FIG. 4A, the traits extraction process 401 begins at a start step 402. The start step 402 is initiated whenever an ecommerce merchant desires to enhance the merchant's eCommerce website 31 (FIG. 1) by adding the functionality of identifying navigational traits from user generated content as well as searchable traits for user generated content with product navigation generated from product reviews. Also, the eCommerce merchant may want to label the products with the traits derived from the product reviews by associating the product to a trait extracted from a review. Labeling is a term used for this association. For example, if a product review for a “dress” on merchant's website mentions that it is good for the “office”, and the traits discovery process extracts the trait “work” then labeling means associating “work” to that “dress”. Finally, the ecommerce merchant may want to show reviews such as review 214 in FIG. 2.

From the start step 402, the process advances to step 404 where the product type for traits extraction process is determined. The determination is made by manually inspecting the products sold by the merchant and how they are organized in a 42 product hierarchy on the merchant's website 31. At this time, appropriate discussions with the merchant could also take place to learn about logical groups of product types. Product types in this regard are product groups like “memory cards”, “coffee makers”. “blenders” or “dresses”. The granularity of this traits extraction process is restricted to product types because the meaning of traits changes across product types. More specifically, the meaning of traits changes with product types. Restricting the trait selection to a given product type makes the traits more accurate and contextual to the products. For example, the mention of “mobile app” in a product review of a“home appliance” product type would most probably imply a mobile app to control an appliance; however, a mention of the same trait in a “smart phone” product type would imply a different meaning, perhaps the ease of installing mobile apps.

Once the product type, for which the traits extraction has to be run (executing or implementing the traits discovery process), is determined, the process advances to a call command 406 (FIG. 4A) that calls the review collection process or sub routine 4400 (FIG. 4B) initiating a start step 4402. Next, in step 4404, the necessary connections over network 80 in FIG. 1 are made so that systems involved in the steps, as shown in FIG. 1, can communicate to each other. This review collection process or routine 4400 facilitates the collection and storage of product and related product attributes (as shown in Table 2) in step 4406 (FIG. 4B) and, product reviews and related attributes (as shown in Table 3) in step 4408. The data is collected from the product discovery system 30 (FIG. 1), more specifically review information which is collected from the product reviews data store 33 and product and related attribute data collected from the product metadata store 35. The review collection can take place in more than one way. For the present invention, it would be sufficient to say that the product data and associated review data is made available by the merchant in a way such that a set of computer instructions can read the data from the data store 33 and store it in the traits discovery data store 50. More specifically the product review module 51 makes the review data available for processing. It is to be understood that the review data can be made available in simple text, an excel file or a simple webpage which can be conventionally scraped and parsed. It is also to be understood that there are many approaches to make the product data and associated review data available by the merchant, as long as the objective of having the merchant provide the data to the system is achieved. The exact format in which the data is made available does not impact the downstream traits extraction or traits storage process. One such method would be to extract each review record in such a way that each attribute field is separated by a comma. The file containing many review records is then subsequently parsed into separate lines and each field of the review record is separated by a comma on each line. It is to be understood that attribute means properties of a review such as “date it was written” “shopper who provided the review” etc. The format is best shown by Tables 2 and 3.

With respect to step 4409 (FIG. 4B), the data collected via this process has the following constraints applied, first, each product should be associated to a unique identifier (Table 2), second, each review should be associated to a product using this unique identifier (Table 3), third, each product should be associated to a product type (Table 2), and, finally, each review item should have a unique identifier (Table 3). The choice of unique identifiers is determined by the product discovery system 30. The unique identifier can be a simple number 1, 2 or 3, etc. or it could be a complex system generating an alphanumeric unique ID such as ABC1000, as long as the number is unique for each product. As shown in Table 3, each customer review includes, but is not limited to, a review text, a review star rating, a date of review, a Product ID, and a Review ID for the product which the review was provided.

Additionally, the user generated review and content collection routine 4400 (FIG. 4B) is responsible for storing the collected information in the traits discovery data store 50 at step 4410, more specifically product reviews store 51, where information is stored in a format similar to Table 3, as indicated hereinafter.

TABLE 2

| Product ID | Product Name | Product Type |
|---|---|---|
| P123 | . . . | . . . |
| P124 | . . . | . . . |
| P125 | . . . | . . . |

TABLE 3

| | Associ- | | | | Review |
|---|---|---|---|---|---|
| Review | ated | Review | | | Star |
| ID | Product | Text | Review Date | Review title | Rating |
| R11 | P123 | smoothies | Jun. 30, 2014 | Great | *** |
| R12 | P123 | easy to use | May 12, 2013 | Nice product | **** |
| R13 | P125 | great value | Apr. 5, 2011 | Not so good | ** |

Once the product and reviews data has been collected and stored in product reviews store 51 by the data collection routine 4400, the traits extraction process 401 proceeds to a call command 408 which calls a data pre-processing routine 4200, as best seen in FIG. 4A.

Considering now the data pre-processing routine 4200 (FIG. 4A) in greater detail, the data pre-processing routine 4200 begins at a start command 4201 that is initiated when the data pre-processing routine 4200 is called by the call command 408. From the start command 4201, the process proceeds to a call command 4202 which conventionally reads each product review saved in the product reviews store 51 and creates a list terms which are present in product attributes, more specifically, product names, product model numbers, and product brand names. The list of terms extracted is stored in product type dictionary 53 (FIG. 1). Product type data dictionary 53 stores a dictionary of synonyms used during the operation of system 8. It is to be understood that product type data dictionary 53 is a conventional database which stores simple words and their meanings. Global data dictionary 54 stores a dictionary of global data such as stop words, product category, etc. It is to be understood that global data dictionary 54 is a conventional database which stores simple words and their meanings. In this regard, each created lexicon or dictionary is comprised of words that are related to the product type and the product items. An example of terms identified and stored in the lexicon are: a) product names; b) brand names; c) color names; and d) model numbers. It is to be understood that this list varies from product type to product type and across different merchant websites. It is to be further understood that this list of words acts as stop-words which, whenever encountered in any product review, are ignored and, hence, do not take part in any kind of processing in traits discovery system 41 (FIG. 1). These words cannot take part in the trait identification process and cannot be traits themselves. The generated list of terms is stored in product type dictionary storage 53.

After the lexicon/dictionaries have been created for the product types and reviewed products, the data pre-processing routine or operation 4200 advances from the call command 4202 to another call command 4204 which calls a punctuation normalization process that will be described hereinafter in greater detail. In overview however, punctuation normalization includes conventional text substitution and text replacement rules which, when applied to each review in the reviews data store 51, improves the performance of traits discovery module 44 by eliminating slang and other unnecessary information from reviews. Consequently, the unnecessary information is not processed. For example, it is a common practice in online reviews that sentences are completed with multiple exclamation marks for example: “I love this dress!! I love the color!!!!!!” A conventional rule to replace multiple exclamation marks with a single exclamation mark is applied. Other similar rules are related to tagging emoji (ideograms or smileys used in electronic messages) present in the reviews or removing unwanted HTML tags such as <br/>. The punctuation normalization functions by reading the reviews from the product reviews system 51, one at a time, and then applying computer instructions to parse the review text and identify character sequences of interest such as “number of exclamation marks at the end of a sentence”. Whenever a character sequence of interest is identified, the product type data dictionary 53 replaces it with a normalized character sequence. The character sequence of interest and the replacement character sequence are stored as rules in a conventional, simple text based file storage within the pre-processing module 43, once the routine completed normalized reviews are updated in the product reviews storage system 51. The updated reviews maintain a link to the original review record by the review identifier shown in Table 2 or Table 3.

Once the punctuation has been normalized, the process proceeds to a call command 4206 that calls a numeric phrase substitution process. The numeric phrase substitution process is very much like the punctuation normalization process in that the numeric phrase substitution process applies conventional text substitution and text replacement rules to reviews. The numeric phrase substitution process is responsible for identifying pre-defined numeric patterns such as simple numbers (1, 2, 3 . . . ) or weights (120 lbs. to 120 pounds) or height (5′10″ and 5 feet 10 inches) and replaces them with one consistent form. For example, the phrase ‘2 year old’ may be replaced as ‘two year old’ or ‘50 lbs.’ may be rewritten as ‘50 pounds’. The numeric phrase substitution functions by reading the reviews from the product reviews storage system 51 one at a time and then applying computer instructions to parse the review text and identify the phrase sequence of interest such as “120 lbs.” Whenever a phrase sequence of interest is identified, the review pre-processing module 43 replaces it with a normalized phrase. The character sequence of interest and the replacement character sequence are stored as rules in a conventional, simple text based file storage within the pre-processing module 43, once the routine completed updated reviews are stored in the product reviews store 51. The updated reviews maintain a link to the original review record by the review identifier stored in the review pre-processing module 43.

Once the number phrases have been normalized, the process proceeds to a call command 4208 that calls an N gram identification process. The N gram identification process determines the most probable bigrams and trigrams from the corpus of the prior customer's review. The process starts by reading each product review from the product review store 51 and then tagging each word in the sentence with parts of speech that the word belongs to through a conventional parts of speech tagger, where each word in a sentence is marked by its part of speech. For example, “this is a great shirt” tagging will output “great” as an adjective and “shirt” as a noun. Parts of speech (POS) tagging is achieved by conventionally applying a natural language parts of speech tagger such as one made available at http://nlp.stanford.edu/softwarelcorenlp.shtml. Each sentence is tagged with pre-defined patterns of tags and marked as probable n-grams. For example, a noun-noun pair such as “summer skirt” or a noun-noun-noun triplet such as “paper towel holder” is marked as possible n-grams.

The patterns for n-gram identification are conventionally predefined and learned by intuition. The following is the list of most common bigrams and trigrams patterns applied in product review store 51 in the process of n-gram identification.

### Common Bigrams and Trigrams Patterns

### Noun-Noun

### Noun-Noun-Noun

### Adjective-to-Verb

Once the probable n-grams are identified, a final list is derived from the probable list. This entails determining an n-gram score for pairs or triplets of consecutive terms. The PMI (Pointwise Mutual Information) score is calculated as a ratio of a probability of finding the words in a particular consecutive sequence versus a probability of finding the words individually or in other consecutive sequences. For example, consider the following equation (Eq. 1):

Score for n-gram AB=(Count AB)/(Unigram score for A*Unigram score for B) (Eq. 1)

Unigram score for A=Count of A−Σ (Count of all n-grams containing A)) or 1 if the difference is 0.

### Example:

The shoe lace on this shoe isn't as good as my other running shoes. But for the price, you can't get a better pair of shoes.
N-gram score of “Shoe Lace”: 1/((4−2)*1); PMI=0.5

As discussed above, a threshold score for PMI is intuitively defined and all bigrams and trigrams with a score higher than the threshold are stored as valid bigrams and trigrams in the product type data dictionary 53, such as n-grams 306 in FIGS. 3A and 3B for example. Once the n-grams are identified, all bigrams and trigrams are treated or considered as being used as single terms for all processing of reviews. This greatly improves the functioning of downstream algorithms. For example, consider the review statement “This jacket has a sturdy front zipper pocket”. The properly identified n-gram “front pocket zipper” aids in identification of trait “sturdy”. An improper identification would cause the trait to be “sturdy front” or “sturdy zipper” which is incorrect.

After all the n-grams have been identified and stored in global dictionary 54, the process advances to a call command 4210 that calls a review tokenization process. It should be noted that during the review tokenization process, each of the prior customer reviews are split into sentences by review pre-processing module 43 and each sentence is stored individually in the product review store 51. This step takes into consideration that each sentence in a review could possibly talk about a different trait and have a different sentiment about it. For example, consider the following review—“This material is lightweight perfect for summers. For winter it is not the right pant.” Each sentence is stored in the product review store 51 with a reference back or link to the prior customer review using an identifier such as Review ID. The conventional sentence spitting rules of the tokenization process are based on grammatical punctuation (such as being separated by an exclamation or a period). More particularly, the reviews are split into sentences using conventional grammatical punctuation rules. After this initial splitting, long sentences are identified based on a number of terms. The long sentences are split further using conventional natural language processing. A conventional POS hierarchy of the sentence is created and the most natural break in the sentence is found to split the sentences.

After the data pre-processing routine 4200 has been completed; e.g. prior customer reviews have been split into sentences, the process returns at a call command 410 which calls a traits association routine or operation 4300, as best seen in FIG. 4A. The topic discovery routine 4300 entails determining the most probable product traits from the product reviews which are stored in traits discovery data store module 51 during the user generated review or content routine 4400 (FIG. 4B).

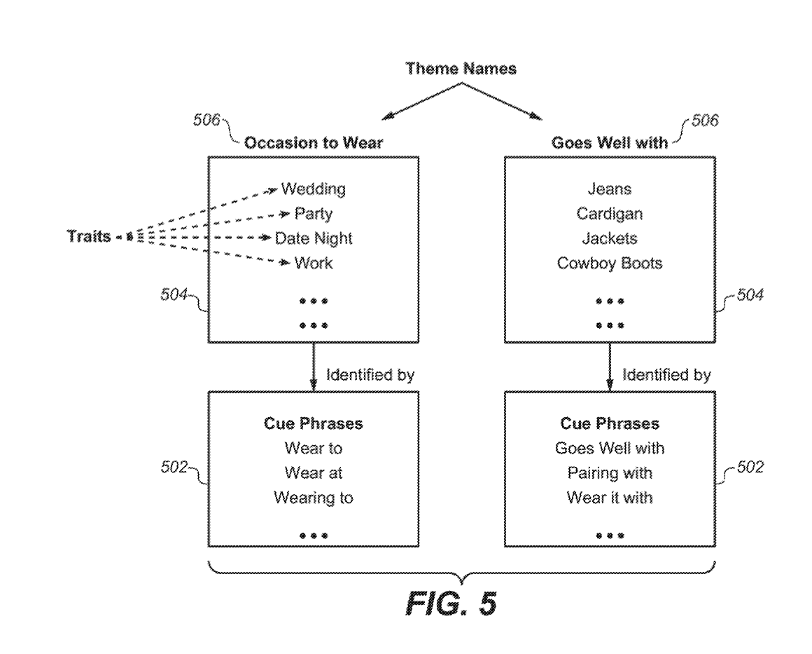

Considering now the traits association routine 4300 in greater detail with reference to FIG. 4A, the traits discovery process 4300 begins at a start step 4301 which was initiated by the call command 410. From the start step 4301, the process proceeds to a call command 4302 that identifies cue phrases in traits discovery module 44. Cue phrases, in this case, are best described with reference to FIG. 5 as common words or groups of words which signal the presence of product traits, such as product traits in 504. For example, the words “to wear to” or “I bought this dress to wear to” in a prior customer review can be treated as a cue phrase.

In a first statement of the previous example, the words “to wear to” imply usage of a product. The cue phrase “wear to” hints to the traits discovery module 41 to extract “wedding” or“date night” as a trait and, as a result, may be utilized to assist in the end user search query “dress for date night”.

Having defined what a cue phrase is, cue phrase identification process 4302 will now be defined in greater detail. Cue phrase identification includes two steps, namely, identification and storage. The identification step is a manual step in which a human being, knowledgeable of the product type in question, evaluates the historic search query logs conventionally located in the merchant's product data store 32, as part of site search index 34 and records the queries of interest on the site search index 34 in site search index storage module 34b. The queries of interest are ones which do not directly mention a structured attribute of a product such as brand, color or type but mention aspects such as usage of the product. For example, queries such as “shoes for hard surfaces”, where “hard surfaces” is a trait, should be recorded by the human operator. The human operator then manually looks at the product reviews stored in product reviews storage 51 for prior customer reviews which mention the trait “hard surfaces”. For example, in a prior customer review “This shoe is perfect for standing on hard surfaces”, the words “is perfect for” will become a cue phrase. This cue phrase is manually selected and stored in traits model storage 52 by the human operator. This cue phrase is later read from the storage by the traits discovery process 4300 to identify many other traits of the product, as shown in step 4304. An assumption is made while executing this process that a single cue phrase can be used to identify more than one trait given a product type for a review. In the previous example, the cue phrase “is perfect for” review is found in prior customer reviews such as “This sandal is perfect for a night out” and “The shoe is perfect for a dressy occasion”. In both of these prior reviews, the cue phrase “is perfect for” indicates to system 8 the presence of traits “night out” and “beach wear”. The human operator is also encouraged to iteratively find more cue phrases. Further expanding on the previous example, a customer review containing the trait “date night” for a product review as such “I bought this sandal for a date night” can be used to identify a new cue phrase “bought this for”. Each cue phrase also provides a logical grouping of the traits (310 in FIG. 3A) also referred to as ‘themes’ or trait groups 308 as shown in FIG. 3A and FIG. 3B. The cue phrases are stored in the traits discovery data 50, more specifically, in product type data store 53, as shown in FIGS. 3A and 3B.

Once the cue phrases are identified, the process moves to text analytics process for trait identification call command 4306. The trait identification step 4306 entails finding and marking, in traits discovery module 44, all prior customer review sentences which contain cue phrases 502 (FIG. 5) and then using a conventional natural language processing approach in traits discovery module 44 to identify traits 504 in those sentences. It is to be understood that most traits 504 are present as nouns within noun phrases and verb phrases in sentences containing cue phrases. It is to be further understood that cue phrase 506 is the cue phrase itself for which traits 504 are the traits found in the cue phrase 506. Traits discovery module 44 utilizes a conventional POS tagger to process each sentence where a cue phrase is present and tags each word which is a noun or part of a noun phrase. Traits discovery module 44 also utilizes a conventional, regular expression, processing program to identify sentences which follow certain POS tag sequences and extracts nouns from noun and verb phrases. The process is repeated for each sentence in each review across the whole corpus. As the process finds the nouns, it also records, in traits product mapping module 55, the frequency of each noun present in the overall review corpus. The nouns which are similar are grouped together by traits product mapping module 55 using a conventional stemmer (stemming programs used in linguistic morphology and informational retrieval to describe the process for reducing inflected (or sometimes derived) words to their word stem). For example, accessory and accessories are grouped together. Less frequent nouns are discarded from the list. A threshold is manually and intuitively decided by a user who looks at all the scores and aspects occurring less than that threshold, as shown in Table 4, below.

TABLE 4

| Sentences Identified | Nouns Extracted |
|---|---|
| Great shoe for standing whole day | Whole day |
| I am a pharmacist and I have to | Hard surfaces |
| stand on hard surfaces | |
| I work in a factory where I have to | Concrete floor |
| stand on concrete floor | |

The previous process produces a list of traits with the frequency in a list similar to the one shown in Table 5 below. The process moves to a manual step 4308 for traits finalization. A human operator, at this time, reviews the list to remove any noise possibly identified due to malformed sentences in the product reviews. During this step, the human operator goes through a list of all traits and identifies the ones which are possibly incorrectly identified. The words/traits ignored by the human operator are added by the manual operator as a traits black list stored in traits product mapping module 55 and are ignored from all future extraction processes.

TABLE 5

| Select | Trait | Frequency | Synonyms | Review sentences |
|---|---|---|---|---|
| Yes | side dishes | 14 | [“dish”, “dishes”] | [“The size is perfect for salads and side dishes.”, “Great for cereal, salad, and |
| | | | | side dishes.”, “The bowls are perfect for large salads and side dishes.”,] |
| Yes | salad | 14 | [“salad”, “salads”] | [“Wonderful for making salad that has to be refrigerated.”, “Also great for |
| | | | | dips and condiments for tacos, salads, etc.”, “The size is perfect for salads |
| | | | | and side dishes.”, “The bowls are little, but they are perfect for small side |
| | | | | dishes like fruit salad, applesauce, or small servings of ice_cream.”] |
| Yes | applesauce | 3 | [“applesauce”] | [“We've been using these since my kids were little and we still love them |
| | | | | now that my kids are older great for goldfish, applesauce, and all kinds of |
| | | | | snacks.”, “These bowls are very small, but perfect for my kids for |
| | | | | applesauce, fruit, ice_cream, and cereal.”, “These bowls are little, but they |
| | | | | are perfect for small side dishes like fruit salad, applesauce, or small |
| | | | | servings of ice_cream.”] |
| No | piece | 3 | [“piece”, “pieces”] | [“Great for packaging large pieces of game like neck or roasts.”, “Great for a |
| | | | | large piece of meat, or any large item you need to keep fresh.”, “nuetral |
| | | | | great for adding coloful pieces”] |

When the identity traits step 4308 is completed, the process moves to a call command 4310 which calls a trait labeling procedure. The objective of this procedure is to search in the review corpus across all sentences and identify all those sentences in the reviews with traits. It is to be understood that this process is a simple text based search. After the traits are identified, a machine learned model is applied to derive a confidence score for the semantic meaning of the trait. A high semantic score indicates more confidence that the trait has the correct contextual meaning. For example, consider following reviews:

Review 1—I bought this necklace for Christmas for my wife.
Review 2—I ordered this necklace online to avoid Christmas crowds in the store.
The term ‘Christmas’ indicates the presence of the trait ‘Christmas Gift’ in both reviews. However, this process aims to derive a high confidence score for trait ‘Christmas gift’ in Review 1, as compared to Review 2.

The confidence score derivation will now be explained. At a high level, the confidence score can be explained as a score which indicates how accurately the presence of certain words in a sentence can predict, through traits discovery module 44 and traits product mapping module 55, the presence of a trait in that sentence. The score calculation is explained as follows. For each ‘trait’ identified by traits discovery module 44 in 4308, the traits discovery module 44 identifies the sentences which have a very high probability of containing a trait. These are sentences which have traits indicated by cue phrases, as in Table 5, from step 4308. From these sentences, the traits discovery module 44 generates a list of terms present in proximity of the trait in those sentences and assigns a probability score to each term. Proximity of a term to the trait is defined as how many terms away is a particular term from the trait. Five (5) terms preceding the trait and five (5) terms following the trait are marked by traits discovery module 44 as proximity terms for the purpose of this invention. Each term is given, by traits discovery module 44, a distance weight age score (1 to 5 with 1 meaning only 1 term away from the trait and 5 meaning 5 terms away from the trait) based on the distance from the trait. Traits discovery module 44 also searches for all other sentences which have mention of a trait. This is achieved by performing a simple search by traits discovery module 44 for trait terms in the sentences of the reviews. For each term, the probability score is defined as the ratio of the number of times the term is present in the sentences with traits to the number of sentences which have a mention of the traits.

The traits discovery module 44 first performs a simple search for traits in the review sentences and tentatively identifies the sentences as containing traits and a base score is assigned. The base score varies with the formation of the trait. The term ‘Christmas Gift’ will have a higher base score for trait ‘Christmas Gift’, as compared to the term ‘Christmas’. Once a base score is assigned, the traits discovery module 44 generates a list of terms present in proximity of the trait. The proximity of a term to the trait is defined as how many terms away is a particular term from the trait. Five (5) terms preceding the trait and five (5) terms following the trait are marked as proximity terms for the purpose of this invention. Each term is given a distance score (1 to 5) by traits discovery module 44 based on the distance from the trait. A score is determined by traits discovery module 44 for each term by finding the probability score of that term, as discussed above. The scores of each term are added by traits discovery module 44 to derive an overall score of the trait in that sentence. The higher the score, the greater the chances are that the trait is mentioned in correct context.

Once each sentence and the confidence score for the trait is identified by sentiment analysis module 45, the call passes on to a call command 4312 where a sentiment score is determined by sentiment analysis module 45 for each trait-review association in process 4500 (FIG. 4C). The call starts at 4502 and moves on to 4504 where a sentiment score for each trait is determined by sentiment analysis module 45 for each review.

Each review is passed through a sentiment classification approach, as illustrated in sub routine 4900 (FIG. 4E). The system 20 uses a conventional lexicon and rules based approach for sentiment classification. In step 4904, traits are conventionally scored individually in a sentence by breaking the review into component sentences by sentiment analysis module 45. In step 4906, the context of the trait in the sentence is conventionally identified by sentiment analysis module 45. In step 4912, the sentiment of the context is conventionally scored by sentiment analysis module 45. Before the sentiment scoring is performed, sentences with no sentiment phrases are removed (step 4908) and the sentence is tokenized (step 4910) by being broken down into terms based on conventional term tokenization rules by sentiment analysis module 45.

For example, given the following review:

“These shoes are great for running, but not for work.”

The traits in the sentence are “running shoes” and “work shoes”. The sentence is broken into its component parts using rules such as splitting on words like “but”, “and”, “however”, etc. This gives two parts: “These shoes are great for running” and “but not for work”.

Traits are given an implicit positive score by sentiment analysis module 45, i.e. the presence of a trait in a sentence is treated as a positive sentiment for the trait. The trait “running shoes” is matched with the part “These shoes are great for running”. The lexicon dictionary 300 is used by sentiment analysis module 45 to identify the positive sentiment word “great”. Thus, “running shoes” gets a high positive score. “Work shoes” is matched with the part “but not for work” by sentiment analysis module 45. There are no sentiment words, and so it is given the implicit positive trait score. The lexicon dictionary 300 now identifies “not” as a negation and the final score for “work shoes” is a negative trait score.

However, certain phrases in the English language have a special meaning and their semantic structure does not indicate their meaning. Consider the following examples:

Example 1: “Believe it or not, these shoes are comfortable!”
Example 2: “These can be worn not just for parties but to work, too.”
Here the phrases “believe it or not” and “not just” do not indicate a negation. The lexicon dictionary 300 identifies such phrases to be ignored from the computation of scores.

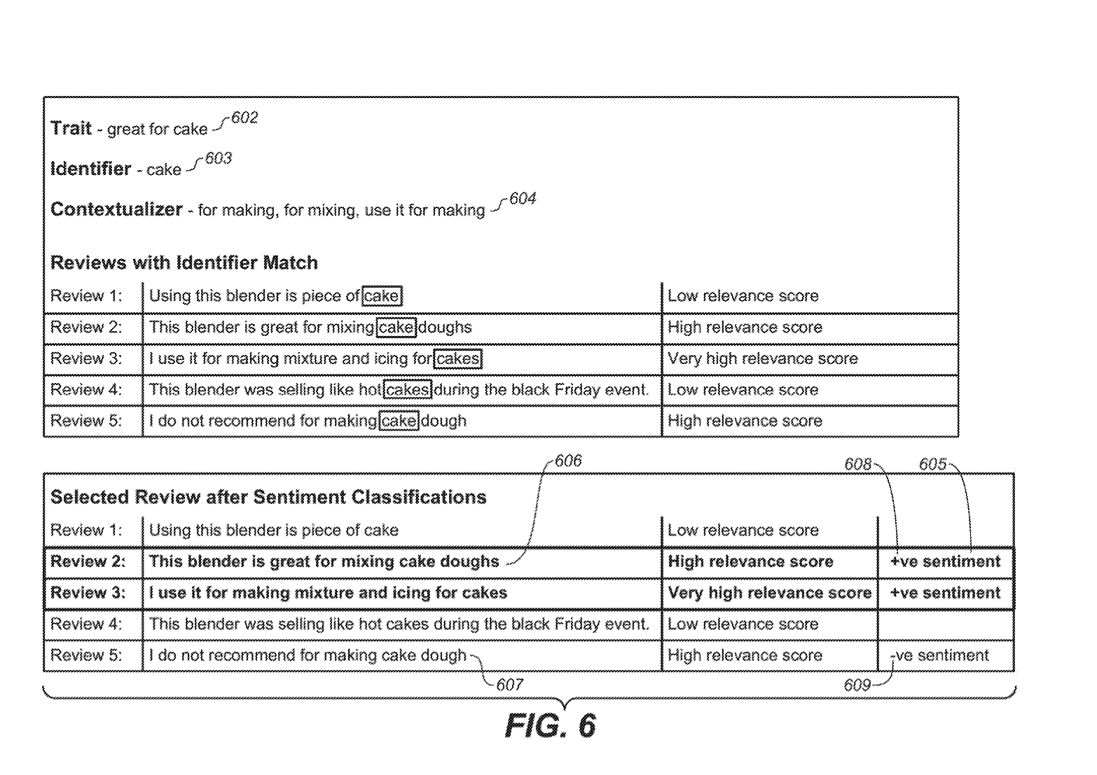

With reference to FIG. 6, FIG. 6 illustrates how a positive score and a negative score is determined from a trait. Consider a trait “Great for making Cake” (602), for a blender. The trait can be identified by the term ‘Cake’ (603) and the surrounding terms in the sentence which are called contextualizers (604). A combination of contextualizers (604) and a trait identifier (603) determines how relevant (605) a trait is for a sentence. Highly relevant sentences (606 & 607) are considered for the sentiment classification process. Sentiment classification produces a positive score (608) or a negative score 609 for the sentiment of a trait (Step 4506, as shown in FIG. 4C).

After the sentiment score for each trait per review is calculated, the process moves on to step 4508 where the overall score for a trait is calculated by sentiment analysis module 45 for the product. The trait-review association score is conventionally averaged by sentiment analysis module 45 over all reviews for the product and an overall score which is stored (step 4510) in data store 55 (FIG. 1) as the product-trait score, such as the product-trait score seen in FIG. 6. The trait-to-product scores are stored in the traits discovery data store 50, more particularly in traits product mapping module 55.

Once the trait-product mapping sentiment score is calculated, the process of sentiment analysis 4500 and traits discovery 4300 is completed and the control is returned back to 412, the trait enrichment process. The trait enrichment process corresponds to the data integration system 60 in FIG. 1 and is responsible for enriching the product site search index 34. The process 412 is a simple process in which product trait association module 46 extracts the stored product-trait mapping from the database 55 and transfers that data in a simple, conventional text format or makes it available via a simple, conventional application programming interface (API) for the site search index over the network 80.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant(s) reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Also, the present invention can be embodied in any non-transitory computer-readable medium for use by or in connection with an instruction-execution system, apparatus or device such as a computer/processor based system, processor-containing system or other system that can fetch the instructions from the instruction-execution system, apparatus or device, and execute the instructions contained therein. In the context of this disclosure, a “non-transitory computer-readable medium” can be any means that can store, communicate, propagate or transport a program for use by or in connection with the instruction-execution system, apparatus or device. The non-transitory computer-readable medium can comprise any one of many physical media such as, for example, electronic, magnetic, optical, electromagnetic, infrared, or semiconductor media but exclude signals, carrier waves, or other transitory signals. More specific examples of a suitable computer-readable medium would include, but are not limited to, a portable magnetic computer diskette such as floppy diskettes or hard drives, a random access memory (RAM), a read-only memory (ROM), an erasable programmable read-only memory, a portable compact disc or removable flash memory. It is to be understood that the non-transitory computer-readable medium could even be paper or another suitable medium upon which the program is printed, as the program can be electronically captured, via, for instance, optical scanning of the paper or other medium, then compiled, interpreted or otherwise processed in a single manner, if necessary, and then stored in a computer memory.

Those skilled in the art will understand that various embodiments of the present invention can be implemented in hardware, software, firmware or combinations thereof. Separate embodiments of the present invention can be implemented using a combination of hardware and software or firmware that is stored in memory and executed by a suitable instruction-execution system. If implemented solely in hardware, as in an alternative embodiment, the present invention can be separately implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies). In preferred embodiments, the present invention can be implemented in a combination of software and data executed and stored under the control of a computing device.

It will be well understood by one having ordinary skill in the art, after having become familiar with the teachings of the present invention, that software applications may be written in a number of programming languages now known or later developed.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed. Accordingly, the description hereinabove is not intended to limit the invention, except as indicated in the appended claims.

Therefore, provided herein are a new and improved system and method for providing review based navigation on an e-commerce website. The preferred system and method for providing review based navigation on an e-commerce website, according to various embodiments of the present invention, offers the following advantages: ease of use, improved ability to discover and shop products, improved ability to analyze product reviews, improved ability to find traits which are commonly used by customers to search products, and improved ability to tag the products with the terms which represent the traits are optimized to an extent that is considerably higher than heretofore achieved in prior, known review based navigation systems on an e-commerce website.

We claim:

1. A system for providing review based navigation on an e-commerce website, comprising:
product discovery means for allowing an end user to perform a query and a navigation request to discover and shop for a product;
trait discovery means for predictively determining a list of traits of the product which can be used with the product discovery means;
traits discovery storage means for storing and accessing information related to the list of traits of the product; and
data integration means for matching a query by the end user to a product associated with the list of traits of the product and to match the query by the end user to a review of the product with the list of traits of the product.

2. The system, as in claim 1, wherein the product discovery means further comprises:
product data storage means for providing information regarding a product, wherein the product data storage means is coupled to a merchant's web site;
product review data storage means for storing information related to a user review of a product item, a product name and a product type; and
a product site search index for responding to the end user query and the navigation request.

3. The system, as in claim 1, wherein the traits discovery means further comprises:
review collection means for collecting a plurality of user reviews;
sentiment analysis means for analyzing the plurality of user reviews to determine a sentiment of the plurality of user reviews;
traits discovery means for discovering a desired product trait;
a review pre-processing means for processing the plurality of user reviews; and
a product trait association means for associating a product trait to a product;

4. The system, as in claim 1, wherein the traits discovery storage means further comprises:
product reviews storage means for storing traits of the product which are extracted from a user generated content store;
traits model storage means for listing traits of the product which can be utilized for product discovery;
traits data storage means for storing a data dictionary; and
traits product mapping means for storing a mapping of traits to each product and product review to which the trait belongs and an association score for displaying to the end user.

5. The system, as in claim 4, wherein the data dictionary further comprises:
synonyms, n-grams, and stop words; and
traits and the groups of traits identified during a preprocessing stage of data.

6. The system, as in claim 2, wherein the data integration means further comprises:
search index enrichment means for providing information related to a product and traits association data which is located in the search index of the merchant's website.

7. The system, as in claim 4, wherein the data dictionary is further comprised of:
a product type data dictionary; and
a global data dictionary.

8. The system, as in claim 4, wherein the traits mapping means is further comprised of:
means for normalizing punctuation.

9. A method for providing review based navigation on an e-commerce website, the method comprising the steps of:
receiving, from a user, a query concerning a specific feature associated with a product;
performing a sentiment analysis of a plurality of reviews associated with the product, wherein the sentiment analysis includes contextualization of the product based on the specific feature present in the plurality of reviews associated with the product; and
facilitating navigation of the e-commerce website based on the sentiment analysis, wherein facilitating navigation includes displaying, in response to the query, a contextualized product, wherein the displaying the contextualized product includes displaying the strengths and weaknesses of the specific feature associated with the product and one or more portions of the plurality of reviews, the one or more portions being relevant to the specific feature.

10. The method, as in claim 9, further comprising the steps of:
extracting traits and features from the plurality of reviews associated with the product; and
tagging the traits and features to a product within a product database to further enrich an activity which relies on how consumers view the product.

11. The method, as in claim 9, wherein the facilitating navigation step is further comprised of the step of:
using a site search query to find relevant products.

12. The method, as in claim 9, wherein the facilitating navigation step is further comprised of the step of:
using a guided site navigation to find relevant products.

13. The method, as in claim 9, wherein the step of performing a sentiment analysis is further comprised of the step of:
determining predictively an exhaustive list of traits to be used for a discovery of the product.

14. The method, as in claim 13, wherein the step of performing a sentiment analysis is further comprised of the step of:
associating discovered traits to a product item and a product review.

15. At least one non-transitory computer-readable medium storing computer-readable instructions that, when executed by a computing device, cause the computing device to:
receive, from a user, a query concerning a specific feature associated with a product;
perform a sentiment analysis of a plurality of reviews associated with the product, wherein the sentiment analysis includes contextualization of the product based on the specific feature present in the plurality of reviews associated with the product; and
navigate the e-commerce website based on the sentiment analysis, wherein navigate includes displaying, in response to the query, a contextualized product, wherein the displaying the contextualized product includes displaying the strengths and weaknesses of the specific feature associated with the product and one or more portions of the plurality of reviews, the one or more portions being relevant to the specific feature.

16. The at least one non-transitory computer-readable medium, as in claim 15, further comprises:
extract traits and features from the plurality of reviews associated with the product; and
tag the traits and features to a product within a product database to further enrich which activity relies on how consumers view the product.

17. The at least one non-transitory computer-readable medium, as in claim 15, wherein navigate causes a site search query to find a relevant product.

18. The at least one non-transitory computer-readable medium, as in claim 15, wherein navigate causes a guided site navigation to find a relevant product.

19. The at least one non-transitory computer-readable medium, as in claim 15, wherein perform includes a sentiment analysis to predictively determining an exhaustive list of traits to be used for a discovery of the product.

20. The at least one non-transitory computer-readable medium, as in claim 19, wherein perform includes a sentiment analysis to associate discovered traits of a product item and a product review.
